(19) United States
(12) Patent Application Publication
(10) Pub. No.: US 2005/0033510 A1
(43) Pub. Date: Feb. 10, 2005

(54) Vehicle-mounted information apparatus

(75) Inventors: Kenichi Kawaguchi, Tokyo (JP); Yuichiro Ichiyama, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/895,946

(22) Filed: Jul. 22, 2004

(30) Foreign Application Priority Data
Aug. 8, 2003 (JP) 2003-290520

(51) Int. Cl. G01C 21/34

(52) U.S. Cl. 701/209; 340/995.19

(57) ABSTRACT

A vehicle-mounted information apparatus performs route guidance of a vehicle to a destination facility according to map information by detecting the current position of the vehicle. It obtains information about the destination facility and the route thereto as acquisition information, and monitors a trouble in the destination facility and its route according to the acquisition information. If a trouble occurs in at least one of the destination facility and its route, the trouble information is displayed to ask a user whether to search for an alternative to the destination facility. If the user issues the search instruction, the vehicle-mounted information apparatus searches for an alternative to destination facility and displays it. Thus, it facilitates the search of the alternative to the destination facility by displaying the trouble information on the road map, if at least one of the destination facility and its route has a trouble.

### BACKGROUND OF THE INVENTION

1. Field of the Invention

The present invention relates to an information apparatus for providing route guidance to a destination facility on the basis of map information by measuring the current position.

2. Description of Related Art

As an information apparatus of this kind, a vehicle-mounted information apparatus is conventionally known which detects the current position of the vehicle by a navigation system such as a GPS (Global Positioning System), and displays the current position on a road map on a display unit. Such a vehicle-mounted information apparatus is called a navigation system. It displays not only the vehicle current position on the road map, but also various types of facilities such as gas stations, restaurants and amusement parks on the road map in terms of facility marks.

There is also an apparatus that displays business conditions such as business hours and holidays of the facilities along with the facility marks on the road map. For example, it acquires facility information by making a user request or an information distribution request to an information distribution center at regular intervals to enable a user to confirm the business conditions when displaying the facility marks on the road map, stores the newly acquired facility information, and displays the facilities using the facility information stored. In this case, the information apparatus displays the facilities along with the marks indicating whether the facilities are open or not (see, Relevant Reference 1, for example).
Relevant Reference 1: Japanese patent application laid-open No. 2000-321082 (pp. 5-7, and FIG. 2)

With the foregoing configuration, the conventional vehicle-mounted information can display the business conditions of the facilities corresponding to the facility marks displayed on the road map. However, even when the destination facility is open while the user is driving the vehicle toward it, the apparatus has a problem of being unable to display trouble information other than the business conditions, even if some unexpected inconvenience has occurred in the destination facility.

For example, it cannot provide the user with the trouble information on the destination facility itself such as the congestion of a parking lot. In addition, it has a problem of being unable to search for an alternative to the destination facility even if the destination facility becomes unavailable or the vehicle cannot reach the destination facility because of some trouble.

### SUMMARY OF THE INVENTION

The present invention is implemented to solve the foregoing problems. Therefore a first object of the present invention to provide a vehicle-mounted information apparatus capable of displaying the trouble information on the destination facility and the route thereto displayed on the road map.

A second object of the present invention it to provide a vehicle-mounted information apparatus capable of searching for an alternative to the destination facility easily when the destination facility is unavailable, or when the vehicle cannot reach it because of closed streets, or the arrival at it is delayed very much.

According to one aspect of the present invention, there is provided an information apparatus including: an information acquiring section for obtaining information about a destination facility and about a route to the destination facility as acquisition information; a facility route monitoring section for monitoring a trouble in the destination facility and the route to the destination facility in accordance with the acquisition information; and a display control section for displaying trouble information when at least one of the destination facility and the route has a trouble.

Thus, it obtains the information about the destination facility and the route thereto, monitors the trouble in the destination facility and its route using the acquisition information, displays the trouble information if at least one of the destination facility and its route has a trouble, and provides the alternative facility. Thus it offers an advantage of enabling the user to know the occurrence of an unexpected trouble in at least one of the destination facility and route easily, and to replace the destination facility by the alternative facility.

### BRIEF DESCRIPTION OF THE DRAWINGS

FIG. 1 is a block diagram showing a configuration of a vehicle-mounted information apparatus of an embodiment 1 in accordance with the present invention;

FIG. 2 is a diagram illustrating an example of a guidance route displayed on the vehicle-mounted information apparatus as shown in FIG. 1;

FIG. 3 is a block diagram showing a configuration of a navigation ECU (Electronic Control Unit) as shown in FIG. 1;

FIG. 4 is a block diagram schematically illustrating an example of a flow of information from an information server to the vehicle-mounted information apparatus;

FIG. 5 is a flowchart illustrating route guidance by the navigation ECU as shown in FIG. 3;

FIG. 6 is a flowchart illustrating the details of step ST2 in FIG. 5;

FIG. 7 is a flowchart illustrating the details of step ST9 in FIG. 6;

FIG. 8 is a flowchart illustrating the details of step ST19 in FIG. 5; and

FIG. 9 is a flowchart illustrating the details of step ST22 in FIG. 8.

### DETAILED DESCRIPTION OF THE PREFERRED EMBODIMENTS

The invention will now be described with reference to the accompanying drawings.

Embodiment 1

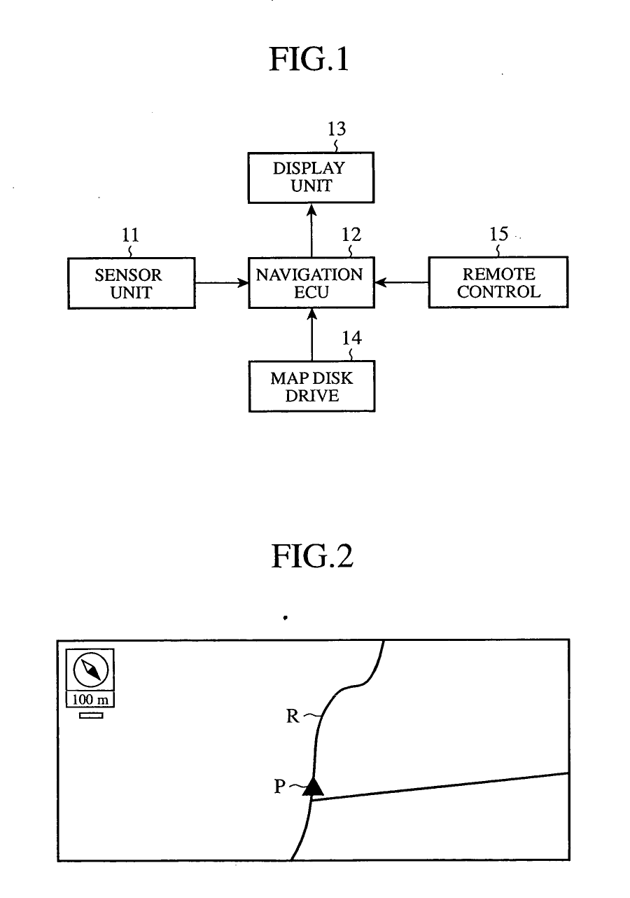

FIG. 1 is a block diagram showing a configuration of a vehicle-mounted information apparatus of an embodiment 1 in accordance with the present invention. In FIG. 1, the vehicle-mounted information apparatus (called “navigation system” from now on) includes a sensor unit 11 having a GPS receiver, a vehicle speed sensor, an angular speed sensor etc., a navigation electronic control unit (navigation ECU) 12, a display unit 13, a map disk drive 14, and a remote control 15. The navigation ECU 12 acquires from the sensor unit 11 the GPS information, vehicle speed information, and vehicle rotation angle information as the sensor information, and obtains the current position of the vehicle from the sensor information. The map disk drive 14 includes a map disk storing the map information. The navigation ECU 12 acquires the map information around the current position of the vehicle from the map disk, and displays the map picture on the display unit 13 according to the map information. The map picture includes a route to the destination such as a facility to which the user travels (called “destination facility” from now on) and the current position of the vehicle. The remote control 15 is used by the user to carry out a variety of settings such as specifying the destination facility, scaling the map picture, and inputting user instructions.

FIG. 2 is a diagram illustrating an example of the map picture, destination route R, and current position P displayed on the display unit 13. In the example of FIG. 2, the scale and orientation are shown at the upper left of the picture.

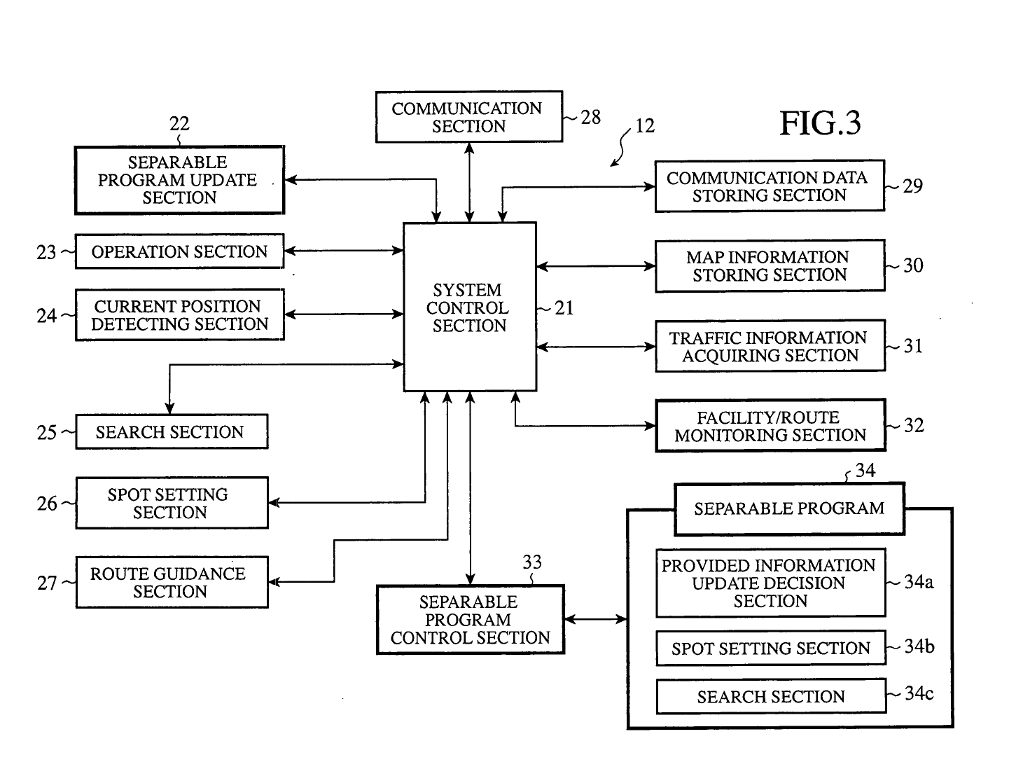

FIG. 3 is a block diagram showing a configuration of the navigation ECU 12. The navigation ECU 12 includes a system control section 21. The system control section 21 controls a separable program update section 22, an operation section 23, a current position detecting section 24, a search section 25, a spot setting section 26, a route guidance section 27, a communication section 28, a communication data storing section 29, a map information storing section 30, a traffic information acquiring section 31, a facility/route monitoring section 32, and a separable program control section 33. The separable program control section 33 controls a separable program 34 including a provided information update decision section 34a, a spot setting section 34b, and a search section 34c. The navigation ECU 12 carries out communication with an information server that will be described later via the communication section 28 and a radio circuit to acquire various communication data (provided information).

The operation section 23 is used for operating the navigation system in response to a user instruction from the remote control 15 such as spot setting and search. The current position detecting section 24 compares the sensor information with the map information, and calculates the current position of the vehicle. The map information storing section 30 stores the map information used for displaying the map picture on the display unit 13, and the map information used for the current position comparison. The search section 25 searches the map information stored in the map disk drive 14 for the various types of facilities classified in accordance with fields. The spot setting section 26 sets a destination (destination facility) in response to the user instruction from the remote control 15. The traffic information acquiring section 31 collects traffic information (VICS (Vehicle Information and Communication System) information, for example) such as traffic congestion and traffic regulation via the communication section 28 and system control section 21 as acquisition information.

The route guidance section 27 displays roads to be followed from the current position to the setting spot (destination facility) on the map picture as a route, and provides the user with speech guidance. In addition, it displays various types of information about the route guidance on the display unit 13, thereby guiding the user from the current position to the setting spot (destination facility).

The separable program 34 has the following functions: obtaining provided information that will be described later; making a decision as to whether it is necessary to update the provided information (provided information update decision section 34a); displaying the provided information; and transmitting instructions such as destination setting to the system control section 21 according to the provided information. The separable program 34 operates on the separable program control section 33. The provided information includes weather information such as snow information, parking lot information, and facility information (such as meeting place conditions, meeting place information and business information).

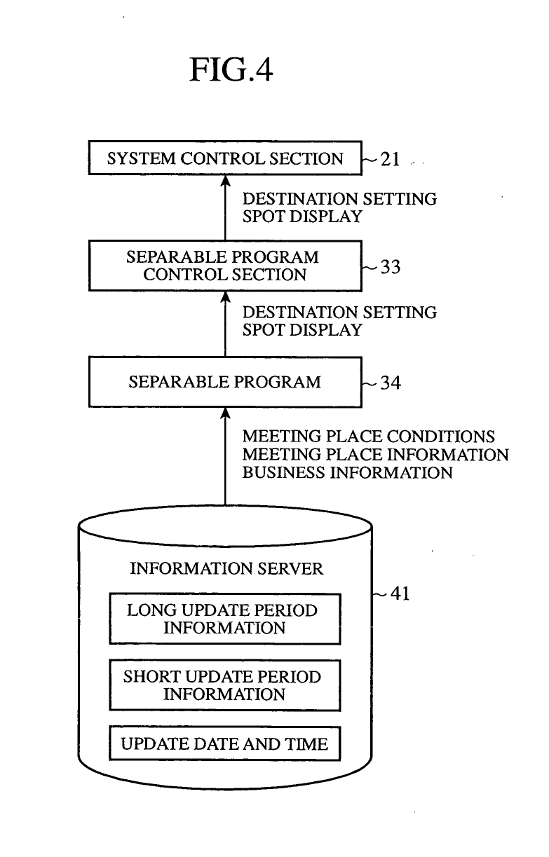

FIG. 4 illustrates a flow of information from the information server 41 to the vehicle-mounted information apparatus. In FIG. 4, the information server 41 stores, as the provided information, information with a long update period (long update period information), information with a short update period (short update period information), and update date and time of the information. For example, when the navigation ECU 12 (FIG. 1) acquires the provided information from the information server 41, the provided information (such as the meeting place conditions, meeting place information and business information) is obtained as the acquisition information by the communication section 28 in real time, and is provided to the separable program 34 from the system control section 21 via the separable program control section 33. In FIG. 4, the communication section 28, system control section 21 and separable program control section 33, which are used when the separable program 34 acquires the provided information, are omitted. The provided information is temporarily stored in the communication data storing section 29, for example. The separable program 34 provides the system control section 21 with the information such as the destination setting and spot display through the separable program control section 33.

According to the acquisition information collected by the separable program 34 and the traffic information (part of the acquisition information) collected by the traffic information acquiring section 31, the facility/route monitoring section 32 monitors the destination facility and the route thereto. If some trouble occurs in at least one of the destination facility and the route, the user is notified of the trouble by speech or picture display. The trouble refers to such inconveniences as the suspension of traffic, bad weather and congestion of a parking lot.

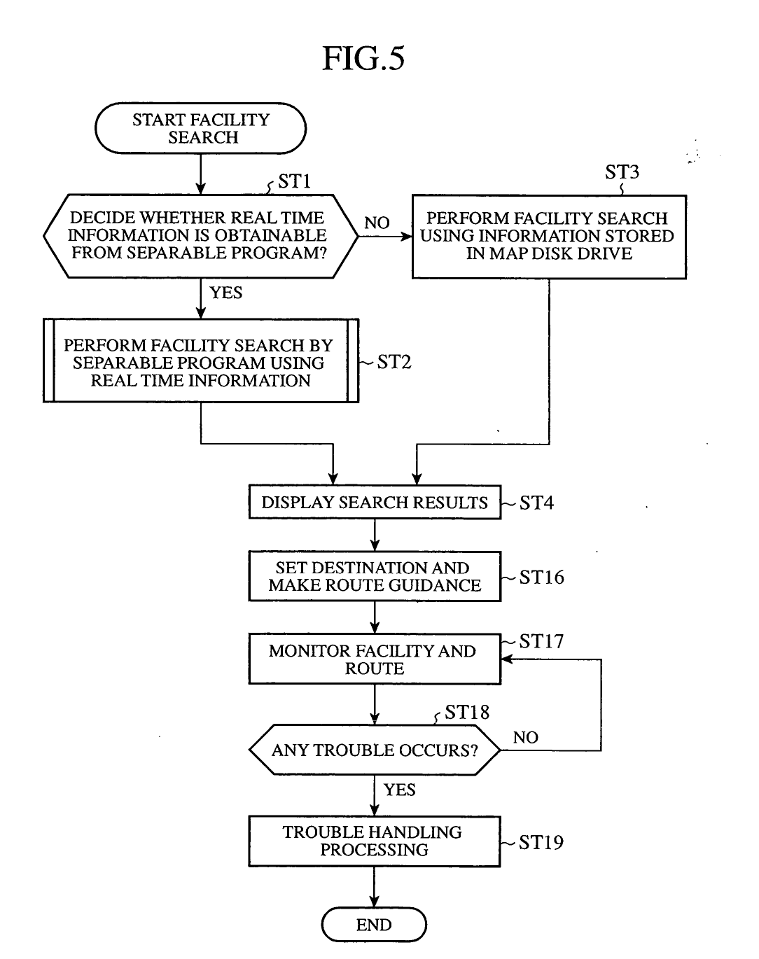

Next, the operation of the present embodiment will be described with reference to FIG. 5.

As described above, the separable program 34 obtains the various pieces of the provided information from the information server 41 as the acquisition information. As shown in FIG. 4, the information server 41 transmits not only the long update period information and short update period information as the provided information (real time information), but also the update date and time information indicating the update date and time of the individual pieces of information.

When the user issues a facility search instruction from the remote control 15 to set the destination facility, the separable program 34 makes a decision as to whether it can acquire the destination facility information (real time information) about the facility search from the separable program 34 itself (step ST1). If the separable program 34 decides that it can acquire the real time information about the destination facility by itself, the separable program 34 starts the search section 34c to search the real time information for the destination facility (step ST2). In contrast, if the separable program 34 makes a decision that it cannot acquire the real time information by itself at step ST1, the system control section 21 starts the search section 25 to search the map information in the map disk drive 14 for the destination facility (step ST3). In either case, the search results are displayed on the display unit 13 (step ST4). Thus, the search sections 34c and 25 operate as a first search section collectively.

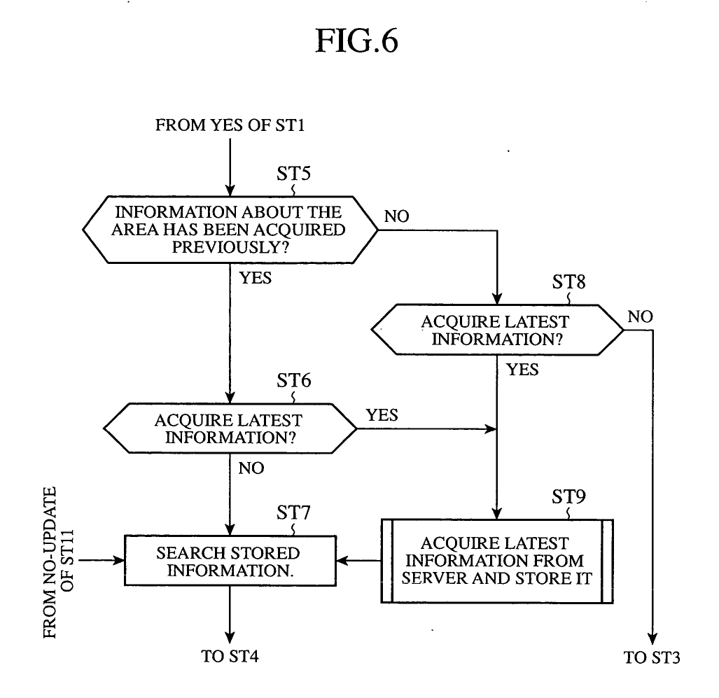

Referring to FIG. 6, the foregoing step ST2 will be described in more detail. To search the real time information for the destination facility, the separable program 34 checks the communication data storing section 29 as to whether it has previously acquired as the real time information the information about the area including the destination facility to be searched for (step ST5). If the separable program 34 makes a decision that it has acquired the information as the real time information previously, it has the provided information update decision section 34a make a decision as to whether the latest information about the area of the destination facility is held or not (step ST6). If it is not necessary to acquire the latest information, the separable program 34 searches the acquisition information (stored information) held in the communication data storing section 29 (step ST7), and displays the search results (step ST4 of FIG. 5).

In contrast, if the provided information update decision section 34a makes a decision at step ST5 that it has never acquired the real time information about the area, the separable program 34 notifies the user whether to acquire the latest information or not (step ST8). For example, the separable program 34 displays a message as to whether to acquire the latest information on the display unit 13 via the system control section 21. When the user issues a user instruction to acquire the latest information via the remote control 15, the separable program 34 acquires the latest information from the information server 41 by the system control section 21 via the communication section 28 as will be described later (step ST9). If the user sends an instruction not to acquire the latest information, the separable program 34 advances the processing to step ST3 of FIG. 5. If the separable program 34 makes a decision that it must acquire the latest information step ST6, it advances the processing to step ST9.

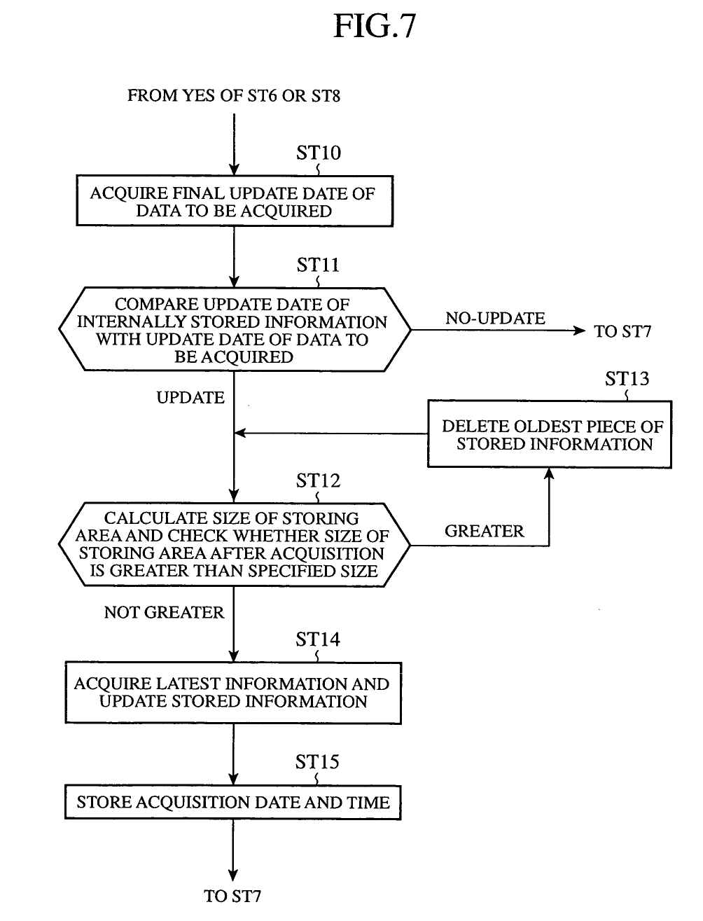

FIG. 7 illustrates the foregoing step ST9 of FIG. 6 in more detail. In response to the acquiring request of the latest information, the separable program 34 acquires from the information server 41 the final update date and time of the real time information (data to be acquired) about the area (step ST10) Then it compares the final update date and time with that of the real time information stored (step ST11). If the separable program 34 makes a decision that the information of the information server 41 has not been updated from the comparison results, it advances the processing to step ST7 of FIG. 6.

On the other hand, if the separable program 34 makes a decision that the information of the information server 41 has been updated at step ST11 (including the case where the real time information about the area is not present), it calculates the size of the storing area of the acquisition information, and checks whether the size is greater than a specified size (step ST12). When the separable program 34 makes a decision that the size is greater than the specified size at step ST12, the separable program 34 deletes the stored information with the oldest update date and time among the stored information (step ST13), and returns to step ST12.

In contrast with this, when the separable program 34 makes a decision that the size is not greater than the specified size at step ST12, it acquires the latest information via the system control section 21 and communication section 28 to update by storing the latest information (step ST14). Then the separable program 34 stores the date and time of acquiring the latest information (step ST15), and searches the stored information at step ST7 (FIG. 6).

Returning to FIG. 5, the search results are displayed only the display unit 13 as described above and the spot (destination facility) obtained as a result of the search is set as the destination. In this case, the spot setting section 26, which is controlled by the spot setting section 34b via the system control section 21, sets the destination. Once the destination has been set in this way, the route guidance section 27 gives the route guidance as described above (step ST16). When the route guidance is started, the facility/route monitoring section 32 monitors the destination facility and the route thereto at specified time intervals according to the traffic information (part of the acquisition information) obtained by the traffic information acquiring section 31 and the acquisition information obtained by the separable program 34 (step ST17). If some trouble such as the suspension of traffic, bad weather, or the parking lot congestion occurs in the destination facility or on the route before the vehicle arrives at the destination (step ST18), the facility/route monitoring section 32 sends a trouble handling request to the separable program 34. Thus the separable program 34 moves to the trouble handling processing (step ST19).

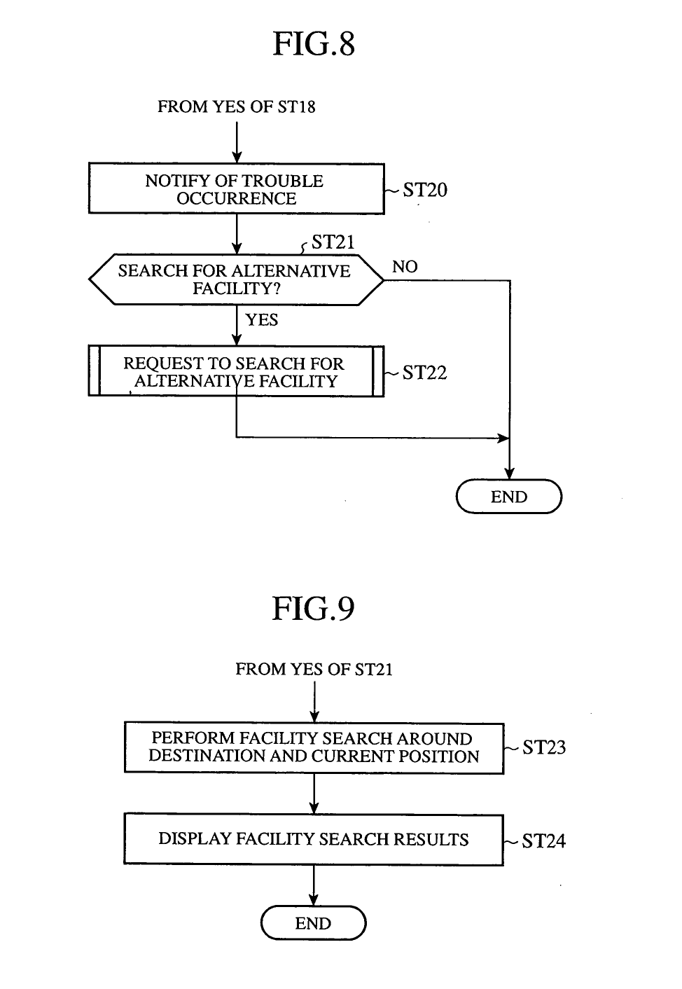

FIG. 8 illustrates the foregoing step ST19 of FIG. 5 in more detail. Receiving the trouble handling request, the separable program 34 has the system control section 21 display the message of the trouble on the display unit 13 (trouble occurrence notification: step ST20). Subsequently, the separable program 34 displays on the display unit 13, information asking the user as to whether to search for any alternative to the destination facility (step ST21). When the user does not require any search for an alternative facility via the remote control 15, the processing is completed, and the route guidance by the route guidance section 27 (FIG. 3) is continued.

On the other hand, if the user requests to search the alternative facility via the remote control 15, the separable program 34 searches for the alternative facility (step ST22). In this case, as illustrated in FIG. 9, the separable program 34 searches the areas near the destination and the current position of the vehicle for the alternative facility as described before in connection with FIG. 5 (step ST23), and displays the search results on the display unit 13 (step ST24). When the user selects an alternative facility from the search results and sets it, the alternative facility becomes the new destination, and the route guidance thereto is carried out as described above.

Although the facility/route monitoring section 32 carries out the monitoring at predetermined time intervals, this is not essential. For example, it can conduct the facility/route monitoring every time when the vehicle moves a specified distance, or by combining the specified time period with the specified distance traveled.

As described above, the present embodiment 1 is configured such that it obtains from the server the provided information about the facilities besides the map information, and the traffic information as the acquisition information, and provides the user with the information as to whether any trouble has occurred in the destination facility or the route thereto according to the provided information. As a result, it offers an advantage of enabling the user to obtain suitable information about the destination facility and its route with ease.

In addition, the present embodiment 1 can search for an alternative to the destination facility, if at least one of the destination facility and its route has a trouble. Thus it offers an advantage of enabling the user to have access to the alternative facility easily.

In addition, as for the acquisition information other than the map information, the present embodiment updates the information by the latest information at appropriate timing. Accordingly, it offers an advantage of being able to reduce the area for storing the acquisition information, and to prolong the period for updating the map information itself.

As is clear from the foregoing description, the communication section 28, system control section 21, separable program control section 33, separable program 34, and traffic information acquiring section 31 operate as the information acquiring section, and the separable program 34 functions as the second search section and decision section.

The information apparatus in accordance with the present invention is configured such that if at least one of the destination facility and the route thereto has a trouble, it displays the message about the trouble, and searches for the alternative to the destination facility. Consequently, it is applicable not only to the vehicle-mounted apparatus, but also to any system for detecting the trouble of the destination facility and/or the route thereto.

1. An information apparatus which detects a current position and carries out route guidance to a destination facility according to map information, said information apparatus comprising:
an information acquiring section for obtaining information about the destination facility and about a route to the destination facility from outside said information apparatus as acquisition information;
a facility route monitoring section for monitoring a trouble in the destination facility and the route to the destination facility in accordance with the acquisition information; and
a display control section for displaying trouble information when at least one of the destination facility and the route has a trouble.

2. The information apparatus according to claim 1, further comprising a first search section for searching for the destination facility in accordance with one of the map information and acquisition information during destination facility search.

3. The information apparatus according to claim 2, further comprising a second search section for search for an alternative to the destination facility if said facility route monitoring section makes a decision that at least one of the destination facility and route has a trouble.

4. The information apparatus according to claim 3, further comprising a decision section for making a decision, when carrying out the destination facility search in accordance with the acquisition information, as to whether to acquire latest information about the destination facility by deciding as to whether information about the destination facility has been acquired previously as the acquisition information.

5. The information apparatus according to claim 4, wherein said information acquiring section compares update date and time of the acquisition information with update date and time of the latest information when acquiring the latest information about at least one of the destination facility and the route, and acquires the latest information as the acquisition information when the update date and time of the latest information is later than the update date and time of the acquisition information.

6. The information apparatus according to claim 5, wherein said information acquiring section deletes the oldest piece of the acquisition information if a memory area required for storing the acquisition information exceeds a specified size when acquiring the latest information.

7. The information apparatus according to claim 1, further comprising a second search section for search for an alternative to the destination facility if said facility route monitoring section makes a decision that at least one of the destination facility and route has a trouble.

8. The information apparatus according to claim 7, further comprising a decision section for making a decision, when carrying out the destination facility search in accordance with the acquisition information, as to whether to acquire latest information about the destination facility by deciding as to whether information about the destination facility has been acquired previously as the acquisition information.

9. The information apparatus according to claim 8, wherein said information acquiring section compares update date and time of the acquisition information with update date and time of the latest information when acquiring the latest information about at least one of the destination facility and the route, and acquires the latest information as the acquisition information when the update date and time of the latest information is later than the update date and time of the acquisition information.

10. The information apparatus according to claim 9, wherein said information acquiring section deletes the oldest piece of the acquisition information if a memory area required for storing the acquisition information exceeds a specified size when acquiring the latest information.

11. The information apparatus according to claim 2, further comprising a decision section for making a decision, when carrying out the destination facility search in accordance with the acquisition information, as to whether to acquire latest information about the destination facility by deciding as to whether information about the destination facility has been acquired previously as the acquisition information.

12. The information apparatus according to claim 11, wherein said information acquiring section compares update date and time of the acquisition information with update date and time of the latest information when acquiring the latest information about at least one of the destination facility and the route, and acquires the latest information as the acquisition information when the update date and time of the latest information is later than the update date and time of the acquisition information.

13. The information apparatus according to claim 12, wherein said information acquiring section deletes the oldest piece of the acquisition information if a memory area required for storing the acquisition information exceeds a specified size when acquiring the latest information.
